(19) United States
(12) Patent Application Publication
(10) Pub. No.: US 2009/0023417 A1
(43) Pub. Date: Jan. 22, 2009

(54) MULTIPLE INTERACTIVE MODES FOR USING MULTIPLE EARPIECES LINKED TO A COMMON MOBILE HANDSET

(75) Inventors: SCOTT B. DAVIS, WALWORTH, WI (US); FRED ZIMBRIC, GURNEE, IL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/780,150

(22) Filed: Jul. 19, 2007

(51) Int. Cl. H04M 11/00

(52) U.S. Cl. 455/403

(57) ABSTRACT

The present invention discloses a mobile communication system that includes a mobile handset and at least two wireless earpieces. The mobile handset can be configured to conduct voice communications with remotely located devices over a mobile telephony network. The wireless earpieces can be configured to be communicatively linked to the mobile handset and to exchange audio with the mobile handset. The mobile handset can enables multiple interactive modes involving the wireless earpieces. At least one of the interactive modes can involve a single individual concurrently using the plurality of wireless earpieces. For example, one of the interactive modes can be a stereo audio mode. At least one of the interactive modes can involve two or more proximately located individuals, where each of the proximate individuals uses one of the wireless earpieces. For example, the interactive modes can include an intercom mode and/or a three-way calling mode.

### BACKGROUND

1. Field of the Invention

The present invention relates to the field of mobile communication technologies and, more specifically, to a solution having multiple modes in which multiple earpieces of a mobile communication handset can be selectively used.

2. Description of the Related Art

Mobile phones are becoming increasingly popular as multi-function devices having substantial computing capabilities. As such, they operate as a portable technology center for telephony communications, Web connectivity, email or text communications, appointment scheduling, contact management, media playback, mobile gaming, and the like. A set of increasingly robust interface peripherals are needed to receive a full benefit of the mobile phone capabilities. For example, wireless stereo headsets/earpieces are needed to properly experience digital media from a mobile telephone device. These earpieces themselves are multifunction peripherals, each having an included microphone as well as a speaker, where the microphone is used for receiving speech input during mobile telephony communications. Currently, wireless stereo headsets/earpieces offer only a limited set of configuration options with respect to voice communication. Generally, these configuration options are to use a stereo headset consisting of a microphone and two earpieces connected by a wire or headband which is active for all types of communication, or a mono headset which consists of a single earpiece with a built-in microphone used for phone calls. Sometimes phone communications are only available in the mono-mode. Conventional options for stereo headsets/earpieces are limited to earpieces physically connected to each other through a cable, wire, or headband. These devices do not lend themselves to easily sharing phone calls between people.

### SUMMARY OF THE INVENTION

The present invention discloses a mobile communication solution for enhancing options for using multiple earpieces/headsets connected to a mobile communication handset in accordance with an embodiment of the inventive arrangements disclosed herein. Hardware/firmware in the handset and earpieces can permit communications in either a master/slave configuration or a peer-to-peer configuration. In a master/slave configuration, one earpiece operates as a master and another as a slave, where all slave communications are routed through the master earpiece before being conveyed to the handset. In the peer configuration, the handset is able to directly communicate with either wireless earpiece. Additionally, software in the handset can control a manner in which audio is conveyed to multiple wireless headsets/earpieces (generically referred to as earpieces) linked to the handset regardless of which configuration (i.e., master/slave configuration or peer configuration) is used. Further, the handset software can interpret commands issued from either earpiece and from the handset itself. These commands can initiate different modes involving the earpieces, such as a stereo mode, an intercom mode, and/or a three-way calling mode. Additionally, the software can define a manner in which the earpieces are shifted from one interactive mode to another.

In stereo mode, the wireless earpieces can function as stereo headphones for listening to music, recorded audio, and the like, with one of the earpieces being used for right channel audio and another for left channel audio. In an intercom mode, a bidirectional/local voice channel can be established between the two earpieces so that users can speak to each other via the earpieces. In the three-way calling mode, the handset can be involved in a mobile telephony session with a remote communicator, and each earpiece can be worn by a different local communicator who are both able to participate in the mobile telephony session, thus establishing a “three-way call” even though only a “two-way” call is occurring over a mobile communication infrastructure.

The present invention can be implemented in accordance with numerous aspects consistent with the material presented herein. For example, one aspect of the present invention can include a mobile communication system that includes a mobile handset and at least two wireless earpieces. The mobile handset can be configured to conduct voice communications with remotely located devices over a mobile telephony network. The wireless earpieces can be configured to be communicatively linked to the mobile handset and to exchange audio with the mobile handset. The mobile handset can enable multiple interactive modes involving the wireless earpieces. At least one of the interactive modes can involve a single individual concurrently using the plurality of wireless earpieces. For example, one of the interactive modes can be a stereo audio mode. At least one of the interactive modes can involve two or more proximately located individuals, where each of the proximate individuals uses one of the wireless earpieces. For example, the interactive modes can include an intercom mode and/or a three-way calling mode.

Another aspect of the present invention can include software for a mobile telephony communication device that includes interactive mode handling software and mode controlling software. The interactive mode handling software can handle an exchange of audio between a handset and at least two wireless earpieces. Modes available can include a stereo audio mode, an intercom mode, and a three-way calling mode. The mode controlling software can change from one of the interactive modes to another responsive to a user selection from a selector of one of the wireless earpieces.

Still another aspect of the present invention can include a method for exchanging audio between a mobile telephone handset and at least two wireless earpieces connected to the mobile telephone handset. In the method, at least one interactive mode can be established responsive to a user selection of an available interactive mode, where available interactive modes include a stereo audio mode, an intercom mode, and a three-way calling mode. Audio can be identified that is to be exchanged with the at least two wireless earpieces in accordance with the established interactive mode. The identified audio is wirelessly exchanged with at least one of the wireless earpieces. The establishing, identifying, and exchanging steps can be performed in a manner determined by software of the mobile telephone handset which is stored in a memory of the mobile telephone handset.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for a mobile communication solution having enhanced dual earpiece options in accordance with the embodiment of inventive arrangements disclosed herein.

FIG. 2 is a schematic diagram illustrating a system for a mobile communication system consisting of a handset and two or more earpieces in accordance with an embodiment of the inventive arrangements disclosed herein.

FIG. 3 is a schematic diagram illustrating a method for changing modes on a mobile communication solution for multi-mode communication in accordance with the embodiment of inventive arrangements disclosed herein.

FIG. 4 is a schematic diagram illustrating a method for changing modes on a mobile communication solution for multi-mode communication in accordance with the embodiment of inventive arrangements disclosed herein.

FIG. 5 is a schematic diagram illustrating a method for changing modes on a mobile communication solution for multi-mode communication in accordance with the embodiment of inventive arrangements disclosed herein.

### DETAILED DESCRIPTION OF THE INVENTION

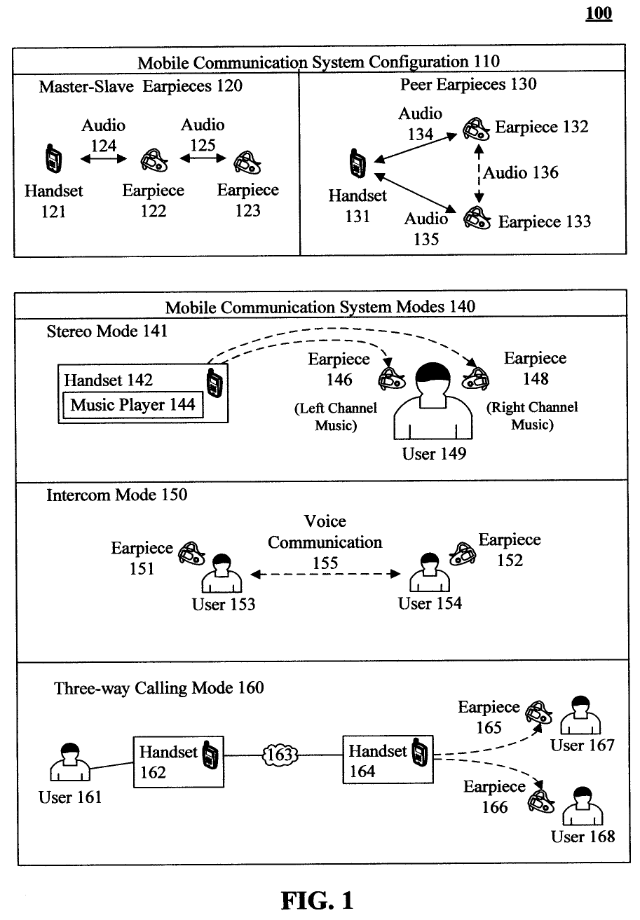

FIG. 1 is a schematic diagram illustrating a system 100 for a mobile communication solution having enhanced dual earpiece options in accordance with the embodiment of inventive arrangements disclosed herein. These options can permit the earpieces to be used in multiple interactive modes, such as a stereo mode 141, an intercom mode 150, and a three-way calling mode 160. These modes 141, 150, 160 can each be controlled by a single handset or can operate by the earpieces directly communicating with each other without handset involvement. That is, the handset is used to accept, manage, and relay audio to the wireless earpieces. User selectable controls of either earpiece can be used to manually shift from one of the interactive modes to another. In one implementation, handset controls can also be used to toggle among modes involving the handset, which may exclude intercom mode 150 depending on implementation specifics.

The wireless earpieces are able to be connected to the handset in accordance with any number of peripheral connectivity standards. Two connectivity configurations 110 are illustrated, which include a master-slave configuration 120 and a peer configuration 130. The interaction modes 140 can be abstracted from the connectivity standard of the communication configuration 110. In other words, interaction modes 140 implemented for the communication system involving multiple earpieces and a base handset can be independent of peripheral connectivity specifics for the earpieces and handset.

In a master-slave configuration, one earpiece 122 can serve as a master earpiece through which all communications to/from the handset 121 are conveyed. The other earpiece 123 is a slave, which uses the master earpiece 122 as a communication intermediary for handset 121 communications. That is, the slave earpiece 123 routes audio 125 directed to the handset 121 through the earpiece 122, and receives audio 124 from the handset 121 from the earpiece 122. The handset 121 can include software controlling and handling the audio 124, 125 streams. In one implementation of configuration 120, the earpieces can be physically distinct from each other, where one is designed as a slave 123 and another as a master 122. In another implementation of configuration 120, the earpieces 122, 123 can be physically and technologically indistinguishable, where handset 121 software/firmware designates one of the earpieces as a master 122 and another as a slave 123.

Regardless of the configuration 110 of a mobile communication system, the system can implement multiple different interaction modes 140. These interaction modes can include one or more personal interactive modes where a single user utilizes two wireless earpieces as well as one or more shared interaction modes where different users utilize wireless earpieces that are wirelessly connected to a single handset. As illustrated in system 100, interaction modes 140 can include stereo mode 141, intercom mode 150, and three-way calling mode 160. These modes are for illustrative purposes only, and the invention is not to be construed as limited in this regard.

One personal interactive mode can be a stereo mode 141, which can be designed to enrich a multi-media experience of a user 149 or to enable stereo telephony communications. Stereo mode 141 can include handset 142, earpiece 146 and earpiece 148, where audio from handset 142 can be transmitted to earpiece 146, 148 as left and right audio channels respectively. The audio can include output from a media playing component 144, such as a music streaming engine for playing music from a remote source and/or an MP3 or other music player 144 for local music playback. The music player 144 can further provide audio for an interactive video playback and/or video gaming sound. A variant of stereo mode 141 can be established for music provided by the handset 142, where music sharing comprises using earpieces 146, 148, where mono-sound can be provided to different earpieces 146, 148.

In intercom mode 150, users 153 and 154 can communicate in real time. Intercom mode can include two earpieces 151, 152 configured to permit a voice communication 155 between the users 153, 154. For example, a motorcycle rider (153) and passenger (154) can use earpieces 151, 152 for interactive, bidirectional communication. These communications are local and can be facilitated/controlled by the handset (not shown). The handset is not necessarily a requirement for conducting intercom mode 150 communications, That is, the earpieces 151 and 152 can be configured to communicate directly with each other when in intercom mode 150 without handset involvement. Earpiece 151, 152 selectable options, such as a multifunction button, can permit either user 152, 154 to toggle in and out of the intercom mode 150.

Three-way calling mode 160 can allow for two proximate users (167, 168) to communicate with a remote third party (161) using a mobile communication system. Three-way calling mode 160 can include handsets 162, 164 that communicate with each other via a mobile telephony network 163. One of the handsets 164 can control/manage multiple earpieces 165, 166, each worn by a different user 167, 168. The earpieces 165, 166 can both transmit and receive audio to/from the users 167, 168 to handset 164. Audio conveyed from handset 162 can be conveyed over network 163 to handset 164, which conveys it to both earpieces 165, 166. Audio that handset 164 receives from either earpiece 165/166 can be conveyed over network 163 to handset 162. Thus, although only two handsets 162, 164 are connected to each other, a three-way call can be established that involves users 161, 167, and 168.

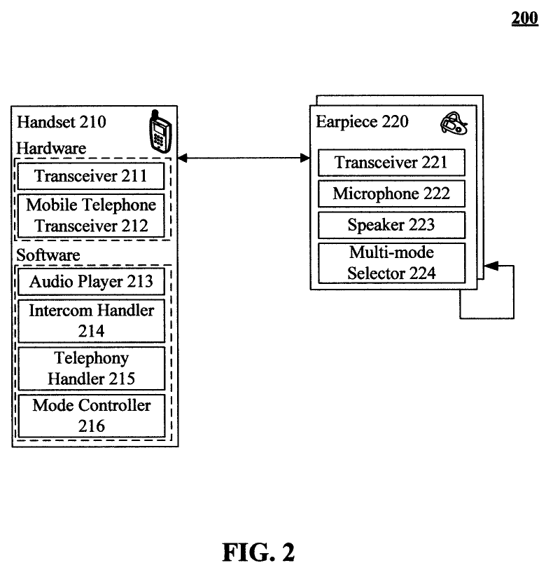

FIG. 2 is a schematic diagram illustrating a system 200 for a mobile communication system consisting of a handset 210 and two or more earpieces 220 in accordance with an embodiment of the inventive arrangements disclosed herein. System 200 shows details for devices which can be operated as indicated by system 100. That is, a single handset 210 can communicate with one or more earpieces 220, and one or more earpieces 220 can optionally communicate with another earpiece to ultimately communicate with the handset 210. In one embodiment, both the handset 210 and earpieces 220 can be commercial off-the-shelf devices which have been optionally firmware/software upgraded to permit the interaction modes described in system 100.

The handset 210 can be any computing device able to exchange voice communications with a remotely located device and able to wirelessly convey audio to one or more earpieces 220. For example, the handset can include a mobile phone, a two-way radio, a Voice over Internet Protocol (VoIP) enabled computer, and the like. In one embodiment, the handset 210 can be a mobile device, which is able to subscribe to a mobile communication carrier to receive telephony communications.

The handset 210 can include a mobile telephone transceiver 212 for connecting to a mobile telephony network and another wireless transceiver 211 for wireless communications with the earpiece 220. The mobile telephone transceiver 212 can conform to any of a variety of communication standards including, but not limited to, Time Division Multiple Access (TDMA), Code Division Multiple Access (CDMA), Global System for Mobile Communications (GSM), Integrated Digital Enhanced Network (IDEN), and the like. The transceiver 212 can further be a WIFI (802.11 based) transceiver that uses a data network for voice communications in accordance with a VoIP. The wireless transceiver 211 can conform to any wireless personal area network (WPAN) standard, such as BLUETOOTH, WIRELESS USB, ZIGBEE, and other radio frequency (RF) standards.

Software associated with handset 210 can include audio player 213, intercom handler 214, telephony handler 215, a mode controller 216, and the like. Audio player 213 can be used to playback audio such as music, spoken word, and other audio. Intercom handler 214 can be a software program which can control synchronization of data exchanges for an intercom mode involving two earpieces 210. Telephony handler 215 can be employed to control telephony operations associated with handset 210 and earpiece 220.

Mode controller 216 can be a software program capable of identifying, managing, and handling changes in communication modes. Mode controller 216 can be responsive to multi-mode selector 224. Mode controller 216 can cause handset 210 to perform actions associated with particular modes. For example, in a three-way call mode the handset 210 can be aware of input from two sources such as two proximate earpieces.

Earpiece 220 can be a wireless stereo headset used for voice communication and audio. Earpiece 220 can be comprised of a transceiver 221, microphone 222, speaker 223, and multi-mode selector 224. Microphone 222 can be used to receive voice input and speaker 223 can be employed to output audio. As such, earpiece 220 can communicate with handset 210 via transceiver 221 to facilitate voice communication with remote parties.

Multi-mode selector 224 can be a selector responsive to a user which can facilitate mode changes. Multi-mode selector 224 can be a physical control located on the earpiece 220 such as a toggle switch, Force Sensing Resistor (FSR), and the like. Multi-mode selector 224 can allow for a user to change the operating mode of an earpiece 220. In one embodiment, a user may press a button to cause the earpiece 220 to function as a phone extension to participate in a three-way call.

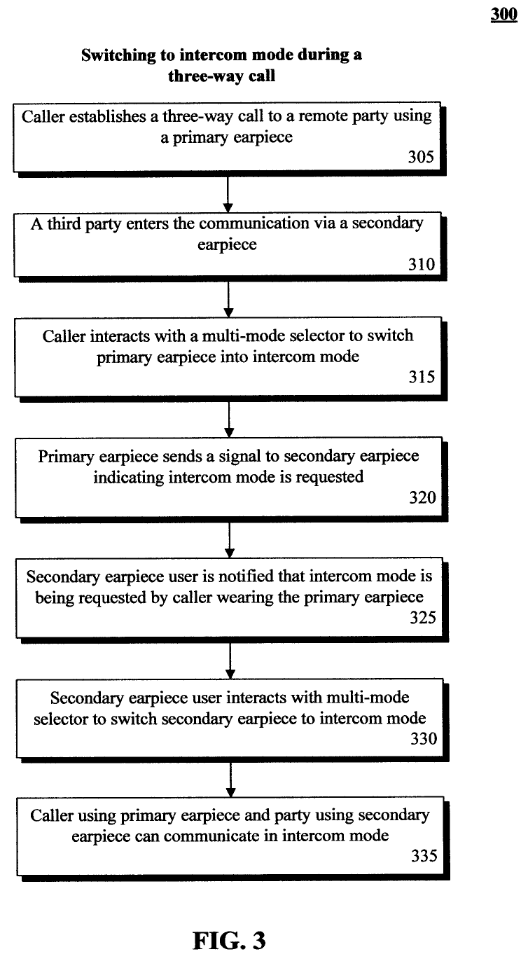

FIG. 3 is a schematic diagram illustrating a method 300 for changing modes on a mobile communication solution for multi-mode communication in accordance with the embodiment of inventive arrangements disclosed herein. Method 300 can be performed in the context of systems 100 and 200. In method 300, a mode change in a multi-mode communication headset can occur wherein an intercom mode is changed to a three-way call mode. Intercom mode can allow for private voice communication exchange between the wearers of the earpieces. A remote party will not be able to hear voice communication that occurs in intercom mode between the earpieces. Thus, the intercom mode can be a “MUTE” variation in which local communicators connected to a handset via different wireless earpieces can communicate.

The method can begin in step 305 wherein a caller establishes a three-way call to a remote device using a primary earpiece. The remote party receiving the call can enter the voice communication session with the caller. In step 310, a third party can enter the communication exchange via a secondary earpiece. The caller, in step 315, can interact with a multi-mode selector on the primary earpiece to switch the earpiece into intercom mode. Step 320 can occur wherein the primary earpiece sends a signal to the secondary earpiece indicating intercom mode is being requested. In step 325, the secondary earpiece user can be notified that intercom mode is being requested by the wearer of the primary earpiece. Secondary earpiece user can interact with a multi-mode selector to switch the earpiece into intercom mode, as shown in step 330. The method can end in step 335, wherein a user using a primary earpiece and a party using a secondary earpiece can communicate in intercom mode. Although not shown, either earpiece wearing communicator can make an earpiece selection to exit the intercom mode and re-establish the ongoing three-way call.

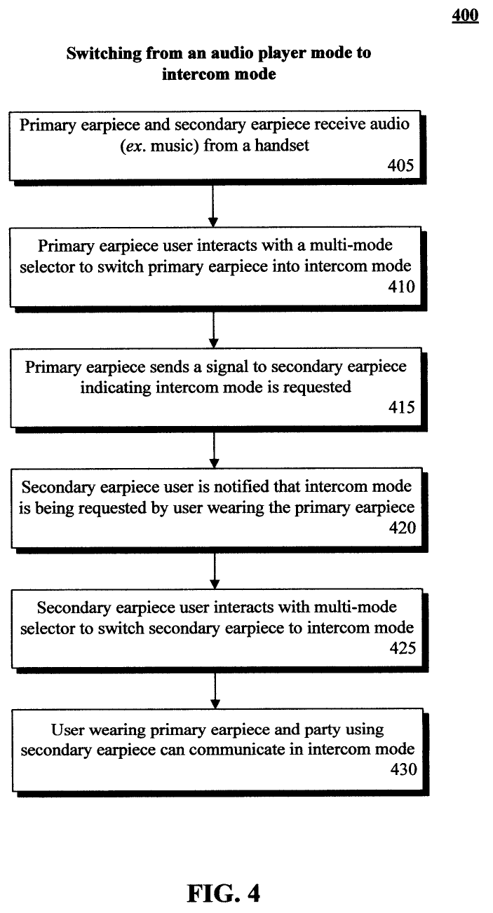

FIG. 4 is a schematic diagram illustrating a method 400 for changing modes on a mobile communication solution for multi-mode communication in accordance with the embodiment of inventive arrangements disclosed herein. Method 400 can be performed in the context of systems 100 and 200. In method 400, a mode change in a multi-mode communication headset can occur where an audio player mode is changed to an intercom mode. Audio mode can include music, spoken audio, and the like being transmitted from a music playing device to an earpiece.

The method can begin in step 405 wherein a primary earpiece and a secondary earpiece receive audio from a handset. In step 410, a primary earpiece user interacts with a multi-mode selector switch to switch the earpiece into intercom mode. Step 415 can occur when the primary earpiece sends a signal to the secondary earpiece indicating intercom mode is requested. The following step 420 can be where the secondary earpiece user is notified that intercom mode is being requested by the user wearing the primary earpiece. In step 425, the secondary earpiece user interacts with a multi-mode selector switch to change the secondary earpiece into intercom mode. The method can end in step 430 wherein a user wearing the primary earpiece and a party wearing the secondary earpiece can communicate in intercom mode.

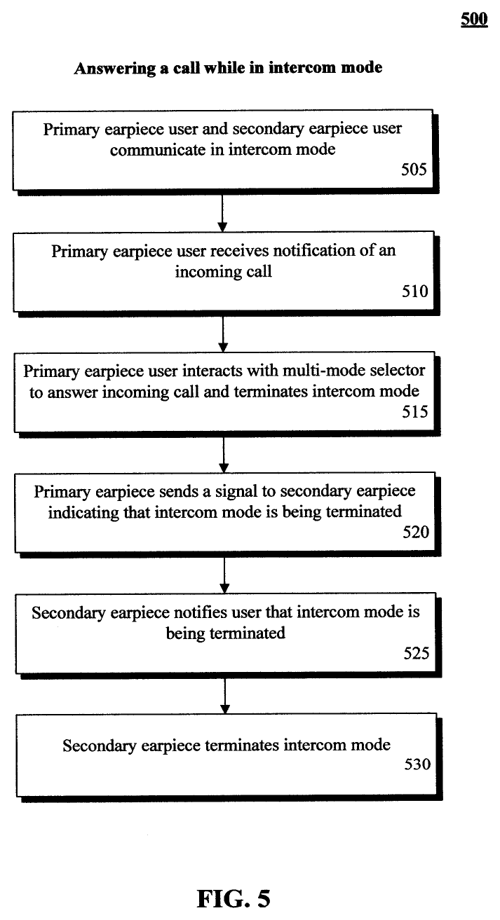

FIG. 5 is a schematic diagram illustrating a method 500 for changing modes on a mobile communication solution for multi-mode communication in accordance with the embodiment of inventive arrangements disclosed herein. Method 500 can be performed in the context of systems 100 and 200. In method 500, a mode change in a multi-mode communication headset can occur wherein an incoming call can be answered while in intercom mode.

The method can begin in step 505 wherein a primary earpiece user and a secondary earpiece user communicate in an intercom mode. In step 510, the primary earpiece user receives notification of an incoming call. The primary earpiece user can interact with a multi-mode selector to answer an incoming call which can result in a termination of intercom mode, as shown in step 515. The method can proceed to step 520 wherein the primary earpiece sends a signal to the secondary earpiece indicating that intercom mode is being terminated. The resulting step can be step 525 wherein the secondary earpiece notifies the user of the secondary earpiece that intercom mode is being terminated. The method can end in step 530 where the secondary earpiece terminates intercom mode.

The methods 300, 400, and 500 are provided to illustrate a switching among the various interactive modes of a mobile communication system involving multiple earpieces connected to a single handset. The types of mode switching shown by methods 300, 400, and 500 are not intended to be comprehensive and the invention is not to be limited in this regard. That is, a variety of other types of switching are contemplated which should be considered within the scope of the present invention. For example, a user can shift from a shared music mode to an intercom mode in one contemplated implementation of the invention. In another example, shifting to intercom mode during a three-way call can prevent outgoing communications from either earpiece wearing communicator while permitting incoming communications from a remote communicator to be heard. In still another example, an incoming call can be received when listening to music in a stereo mode, which can cause software of the handset to automatically shift operations into a telephony communication mode.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A mobile communication system comprising:
a mobile handset configured to conduct voice communications with remotely located devices over a mobile telephony network; and
a plurality of wireless earpieces configured to be communicatively linked to the mobile handset and to exchange audio with the mobile handset, wherein the plurality of wireless earpieces are capable of a plurality of interactive modes, wherein at least one of the interactive modes involves a single individual concurrently using the plurality of wireless earpieces, and wherein at least one of the interactive modes involves a plurality of proximately located individuals where each of the proximate individuals uses one of the plurality of wireless earpieces.

2. The system of claim 1, wherein the interactive modes comprise a stereo audio mode, an intercom mode, and a three-way calling mode.

3. The system of claim 1, wherein the interactive modes comprise a three-way calling mode, said three-way calling mode connecting three individuals in a voice communication, two of which are geographically located near the mobile handset, wherein each of the two individuals use one of the plurality of wireless earpieces, and wherein another of the three individuals communicates from a remotely located communication device linked to the mobile handset via the mobile telephony network.

4. The system of claim 1, wherein the plurality of wireless earpieces are communicatively linked in a master-slave configuration.

5. The system of claim 1, wherein the plurality of wireless earpieces are communicatively linked in a peer configuration.

6. The system of claim 1, wherein the mobile handset and each of the wireless earpieces are commercial off-the-shelf devices, and wherein software/firmware of at least one of the mobile handset and the wireless earpieces manage operations relating to each of the interactive modes.

7. The system of claim 6, wherein the software/firmware has been upgraded to enable at least one of the interactive modes during an aftermarket software/firmware upgrade.

8. The system of claim 1, wherein each of the plurality of earpieces comprises a selector for changing the interactive modes from one state to another.

9. The system of claim 1, wherein each of the wireless earpieces comprises a microphone and a speaker.

10. The system of claim 1, wherein the mobile handset comprises audio player software, intercom handler software, telephony handler software, and mode controller software, said audio player software, intercom handler software, telephony handler software, and mode controller software including a set of programmatic instructions stored within a machine readable medium contained within the mobile handset, said set of programmatic instructions being readable by hardware of the mobile handset.

11. Software for a mobile telephony communication device comprising:
interactive mode handling software configured to handle an exchange of audio between a handset and at least two wireless earpieces, wherein said interactive mode handling software implements a stereo audio mode, an intercom mode, and a three-way calling mode; and
mode controlling software configured to change from one of the interactive modes to another responsive to a user selection from a selector of one of the wireless earpieces, said interactive mode handling software and said mode controlling software including a set of programmatic instructions stored within a machine readable medium contained within the mobile telephony communication device, said set of programmatic instructions being readable by hardware of the mobile telephony communication device.

12. The software of claim 11, wherein the stereo audio mode conveys left channel sound to a speaker of one of the wireless earpieces and conveys right channel sound to a speaker of another one of the wireless earpieces.

13. The software of claim 12, further comprising:
music playing software configured to play music files stored in a memory local to the mobile telephony communication device, wherein when in said stereo mode music played by the music playing software is played in stereo as the left channel sound and the right channel sound.

14. The software of claim 11, wherein the intercom mode permits a user wearing one of the wireless earpieces to speak to a user wearing another of the wireless earpieces over a local bidirectional voice channel.

15. The software of claim 11, wherein the three-way calling mode connects three individuals in a voice communication, two of which are connected to the handset via one of the plurality of wireless earpieces, and wherein another of the three individuals communicates from a remotely located communication device linked to the handset via a mobile telephony network.

16. The software of claim 11, wherein the software further comprises:
audio player software, intercom handler software, telephony handler software, and mode controller software, said audio player software, intercom handler software, telephony handler software, and mode controller software including a set of programmatic instructions stored within a machine readable medium contained within the handset, said set of programmatic instructions being readable by hardware of the handset.

17. A method for exchanging audio between a mobile telephone handset and at least two wireless earpieces connected to the mobile telephone handset comprising:
establishing at least one interactive mode from a plurality of user selectable interactive modes, wherein said interactive modes comprise a stereo audio mode, an intercom mode, and a three-way calling mode; and
identifying audio to be exchanged with the at least two wireless earpieces in accordance with the established interactive mode;
wireless exchanging the identified audio with at least one of the wireless earpieces, wherein the establishing, identifying, and exchanging steps are performed in a manner determined by software of the mobile telephone handset, which is stored in a memory of the mobile telephone handset.

18. The method of claim 17, wherein the established interactive mode is a stereo audio mode, wherein said wireless exchanging step conveys left channel sound to a speaker of one of the wireless earpieces and conveys right channel sound to a speaker of another one of the wireless earpieces.

19. The method of claim 17, wherein the established interactive mode is an intercom mode, wherein said wireless exchanging step permits a user wearing one of the wireless earpieces to speak to a user wearing another of the wireless earpieces over a local bidirectional voice channel.

20. The method of claim 17, wherein the established interactive mode is a three-way calling mode, wherein said wireless exchanging step connects three individuals in a voice communication, two of which are connected to the mobile telephone handset via one of the earpieces, and wherein another of the three individuals communicates from a remotely located communication device linked to the mobile telephone handset via a mobile telephony network.
